(19) United States
(12) Patent Application Publication
(10) Pub. No.: US 2015/0144521 A1
(43) Pub. Date: May 28, 2015

(54) STORAGE AIDS COMPRISING PLANT PROTECTANTS AND THEIR USE

(71) Applicants: SE MA GESELLSCHAFT FÜR INNOVATIONEN MBH, Coswig (DE); RKW SE, Frankenthal (DE)

(72) Inventors: Karin Rauch, Leipzig (DE); Jens Schönewerk, Grimma (DE); Tilo Wachs, Remagen (DE)

(21) Appl. No.: 14/402,483

(22) PCT Filed: Jul. 22, 2013
(86) PCT No.: PCT/IB2013/056011

§ 371 Date: Nov. 20, 2014

(30) Foreign Application Priority Data
May 22, 2012 (DE) 10 2012 009 965.7

(51) Int. Cl. B65D 81/34; B65D 81/24; A01N 47/20

(52) U.S. Cl. CPC B65D 81/34; A01N 47/20; B65D 81/245
USPC 206/524.3; 493/328

(57) ABSTRACT

A storage aid which is finished with a plant protectant so as to extend the shelf-life of agricultural produce, and to the use of said storage aid. The storage aid includes at least: a. a carrier film and/or a carrier paper, b. a permeable cover layer, the carrier film and the cover layer being joined together by an adhesive layer, the adhesive layer including between 0.1 and 70% by weight of a plant protectant.

### CROSS REFERENCE TO RELATED APPLICATIONS

This application is a United States National Phase Application of International Application PCT/IB2013/056011 and claims the benefit of priority of German Patent Application 10 2012 009 965.7 filed May 22, 2012, the entire contents of which are incorporated herein by reference.

### FIELD OF THE INVENTION

The present invention pertains to a storage aid, which is finished with a plant protectant to extend the shelf-life of agricultural products and to the use of these storage aids.

### BACKGROUND OF THE INVENTION

It is known that the sprouting of all types of crops, for example, oats, barley, corn, rice and rye, but also other agricultural products, for example, potatoes, sugar beets, tomatoes, peas, leeks, asparagus, fodder grasses and red clover during storage can be inhibited or prevented by treatment with gamma radiation or by hot fumigation with chemicals, for example, propham (IPC) or chlorpropham (CIPC).

However, there are concerns regarding possible health hazards in case of the prior-art sprout suppression methods. For example, potatoes may be consumed only 42 days after treatment at the earliest after a conventional treatment by means of hot fumigation with the growth regulator CIPC.

The use of isopropyl-N-(m-chlorophenyl)-carbamate (CIPC) (Ia) as an extremely effective sprouting inhibitor in Solanum tuberosum was first reported by Rhodes et al. (Research, 1950, 3, 189-190).

Representatives of typical growth regulators are, for example, carbamates of general formula (I):

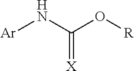

in which Ar denotes an aryl or hetaryl radical, R denotes an alkyl radical and X denotes oxygen or sulfur. In case of the defined structure (Ia), Ar is a phenyl radical, R is an iso-propyl radical, and X is oxygen.

Parochetti et al. (Weeds, 1966, 14, 281-285) disclose the effect of temperature, moisture content in the soil, type of soil and air flow on the volatility of isopropyl-N-phenyl carbamate (IPC) and isopropyl-N-(m-chlorophenyl)-carbamate (CIPC). The observed volatility of IPC and CIPC from an air-dried soil (with <1 μg/cm²) is very low. Liebmann et al. (Chemische Technik, 1964, 16(4), 236-237) also disclose an extrapolated vapor pressure of 0.13 mPa for CIPC at a temperature of 20° C. This means that only a CIPC concentration of 1.26 ppb or approx. 11 μg/m³ is reached under ideal conditions of vapor saturation at a temperature of 20° C.

There are numerous other growth regulators, such as tecnazen and maleic acid hydrazide, which have an action similar to that of isopropyl-N-(m-chlorophenyl)-carbamate, but are not allowed to be used in Germany. In case of maleic acid hydrazide, the limitation for field application was made less stringent, because impurities in the form of free hydrazine, which are due to the manufacturing process, could be drastically reduced. The use of isopropyl-N-(m-chlorophenyl)-carbamate has also been subject to restrictions since 2001 in the private sector. The dilemma represented by the drawbacks in terms of rather substantial losses during storage and impairment of quality, on the one hand, and the endeavors to offer foods that are as free from residues as possible, on the other hand, can only be reconciled primarily by drastically reducing the quantity applied and by ruling out errors in application with absolute certainty. These errors in application cannot be ruled out with certainty in case of the conventional methods available for distributing the growth regulator. The especially disadvantageous variant, according to which the preparation is applied in the solid form to potatoes, has been largely replaced by the spraying or hot fumigation methods (DE 199 13 591 A1; US 2009/0203527 A1). However, considerable differences in concentrations may still develop in the product being stored in this case as well. Direct wetting with the concentrated preparation is also employed in practice, as is indicated by investigations on residues (J. Environm. Science a. Health, 44B (2009) 1-6; Acta Chim. Slov. 57 (2010) 972-979) of the active ingredient isopropyl-N-(m-chlorophenyl)-carbamate in potatoes.

There are a number of nature-identical active ingredients (Potato Res. 24 (1981), 61-76), which are said to have a similar growth-regulating action. In reality, the drawbacks that arise in connection with the characteristic olfactory properties and the fact that the odor threshold is markedly exceeded at the necessary concentrations are a possible reason why these substances have not been used so far. An intensification of the individual effects of carvone and menthol in case of the use of a mixture of these substances is described in an application filed in 2001 (DE 694 27 407 T2). However, the use of this combination has not been able to become successful.

DE 103 29 275 A1 discloses a three-layer composite of a transferable adhesive layer and a carrier film, which are not connected permanently with one another, where the adhesive layer may contain volatile ingredients.

EP 0 142 658 A1 discloses carriers in the form of films, nonwovens and fabrics from organic material with integrated active ingredients, where an active ingredient is integrated in the polymer matrix of the carrier. The integrated active ingredient is able to slowly migrate from the polymer matrix.

DE 691 22 525 T2 discloses the manufacture of multilayer films, which comprise more than three layers, wherein the multilayer films comprise a core layer, a corresponding other layer, which is laminated onto each side of the core layer and contains an additive. The multilayer film is manufactured by a method of extruding all layers, wherein an additive is encapsulated in a thermoplastic resin in a first step of the manufacturing process and pellets are thus obtained, which are mixed in a second step with a second thermoplastic resin, which has a lower melting point than the first resin.

### SUMMARY OF THE INVENTION

An object of the present invention is therefore to provide a protective storage aid for preserving and inhibiting the sprouting of product being stored, which shall guarantee direct contamination of the product being stored with a plant protectant with certainty and guarantee at the same time a constant concentration of the plant protectant in the ambient air over the entire storage time of the crop and other agricultural products being stored.

The object is accomplished according to the present invention by a storage aid comprising at least:

a) one carrier film and/or one carrier paper and

b) one permeable cover layer,

wherein the carrier film and the cover layer are connected by an adhesive layer,
wherein the adhesive layer contains between 0.1 wt. % and 70 wt. %, preferably between 0.5 wt. % and 60 wt. % and especially preferably between 0.5 wt. % and 50 wt. % of a plant protectant.

It was surprisingly found that the adhesive layer acts as a long-term depot for an active ingredient (i.e., plant protectant) and thus encloses same when incorporating a plant protectant, which preferably has low volatility, in the adhesive layer of a storage aid according to the present invention. Direct contact between an active ingredient incorporated in the adhesive layer and the product being stored is advantageously ruled out by the storage aid according to the present invention. In addition, the structure of a storage aid according to the present invention represents a protection against contact for the user and end consumer against a plant protectant.

Source references are given above and will be given below only insofar as they are necessary for the person skilled in the art for understanding the present invention.

In the sense of the present invention, a storage aid is a flexible and permanent multilayer composite material or a laminate, which comprises at least one carrier film and/or one carrier paper and at least one permeable cover layer, wherein an adhesive layer is located between the carrier film and/or the carrier paper and the cover layer, wherein the adhesive layer contains an active ingredient, which preferably has low volatility and is selected from the group of the growth regulators and fungicides, and is especially preferably selected from the group of the carbamates and benzimidazoles.

A permeable cover layer is preferably a perforated cover film (for example, one made of PE, PP, PS, PET, PVC, polylactide or coated cellophane as well as blends) or a nonwoven (for example, one consisting of PE, PP, polyester, viscose or polyamide) or a perforated paper.

The carrier films and/or perforated cover films are flexible, strip-shaped films, which preferably consist of a nonsticky material, wherein the type of carrier films and/or perforated cover films used is not subject basically to any limitations. Independently from one another, commercially available plastics, for example, PE, PP, PS, PET, PVC, polyester, cellophane, cellulose, polyvinylidene chloride, styrene-butadiene block copolymers, ethylene-vinyl acetate copolymers (EVA), ethylene-vinyl alcohol copolymers (EVOH), ethylene-propylene terpolymers, polyacrylonitrile, polyacrylates, polyamides (PA), polylactide, cellophane (also known under the name cellulose hydrate or cellophane), as well as blends (i.e., composites of these materials, which are known to the person skilled in the art along with their properties and are commercially available in a large number, can be considered for use as suitable materials for the carrier film and/or cover films.

Carrier films and cover films made of PE, PP, PS, PET, PVC, polylactide or coated cellophane as well as blends are especially preferred, as a rule, for economic reasons.

The carrier film and/or cover film preferably has an area weight between 5 g/m² and 200 g/m², especially preferably between 10 g/m² and 120 g/m², and especially preferably between 25 g/m² and 100 g/m². The area weight is defined as the weight of material per unit area of material in g/m².

The carrier paper is preferably a sulfate or kraft paper with an area weight between 60 g/m² and 140 g/m² and especially preferably between 70 g/m² and 90 g/m².

The perforated cover film and/or carrier film, especially the perforated cover film, are preferably finely perforated, as a result of which the film is permeable to gases, and continuous and uniform release of active ingredient to the ambient air is thus guaranteed.

A perforated carrier film or cover film preferably has between 10 and 500, especially preferably between 20 and 400 and especially preferably between 200 and 350 holes per cm² of the film, and the free surface of a film resulting from the holes accounts for between 1 and 25 area %. The holes of the carrier film and/or of the cover film are not connected with one another and have a diameter of 50 μm to 3 mm, especially 0.1 mm to 2 mm, and especially preferably 0.2 mm to 1 mm. Uniform distribution of the active ingredient by convection is advantageously facilitated by the size of the holes in the carrier film and/or cover film in case of thick, compact storage aids.

As an alternative, the permeable cover layer is a nonwoven consisting of PE, PP, polyester, viscose or polyamide or a paper.

A nonwoven is a fiber composite that consists of fibers lying loosely together, wherein the fibers are not yet connected with one another. To make it possible to process and use the nonwoven, it is usually strengthened, for which various methods may be used, which are known to the person skilled in the art. The length of the fibers used in a nonwoven is not subject to any particular restrictions, i.e., the fibers used may be both so-called short and/or long fibers as well as fiber fragments. Short and/or long fibers with a mean length between 5 mm and 150 mm, preferably between 10 mm and 120 mm and especially preferably between 20 mm and 100 mm have proved to be especially preferred.

The paper of the permeable cover layer is preferably a perforated or needled sulfate or sulfite paper with an area weight between 60 g/m² and 140 g/m², especially preferably between 70 g/m² and 90 g/m², containing 2 to 10 and preferably 2 to 5 holes per cm² of paper.

The purpose of the carrier film and/or of the carrier paper and/or of the permeable cover layer is to protect the permanent adhesive layer from undesired contact with foreign objects and to guarantee uniform release of the plant protectant incorporated therein.

The adhesive layer of the storage aid according to the present invention preferably consists of an elastic adhesive with permanent adhesive action and low polarity (which is coordinated with the growth regulator), as a result of which the diffusion of the incorporated growth regulator is advantageously facilitated.

The adhesive of an adhesive layer is preferably selected from the group comprising polyolefin, polyurethane adhesives, plastisols, acrylate resins, PSA pressure-sensitive adhesives, natural adhesives or a mixture of these adhesives.

Especially rapid release of active ingredient is inherently achieved by a slight interaction between the adhesive matrix and the growth regulator, and the adhesive is therefore preferably polyisobutylene, a one-component or two-component (K)-polyurethane system, PVC plastisol or a mixture of these adhesives.

A natural adhesive selected from among starch and modified starch (e.g., amylopectin and maltodextrin), cellulose ester and/or ether (e.g., methyl and acetyl cellulose), lignin products (e.g., lignosulfonates, organosolv lignin), glutin lime (bone lime) and/or resins (e.g., colophony) is preferred.

For an optimal protection against contact, a homogeneous distribution of the growth regulator in the adhesive layer is optimal, whereby the differences in polarity between the growth regulator and the adhesive have a great effect on the release of active ingredient. In case of polar growth regulators having especially low volatility, the growth regulator is advantageously released from a nonpolar adhesive layer containing polyisobutylene markedly more rapidly than from a nonpolar adhesive layer containing a one-component or two-component polyurethane system or cyanoacrylate adhesive.

At the same time, an adhesion-reducing, high concentration of the growth regulator can be advantageously compensated by selecting high-molecular-weight polyisobutylene, preferably with a molecular weight between 10,000 g/mol and 5,000,000 g/mol, especially preferably between 10,000 g/mol and 1,000,000 g/mol, and especially preferably between 10,000 g/mol and 500,000 g/mole, as a result of which the depot effect of the storage aid according to the present invention is increased and its service life is prolonged.

The corresponding compositions for one-component and two-component polyurethane systems are very well known to the person skilled in the art or can be found, for example, in the manual “Polyuretane” [Polyurethanes] (Ulrich Meiner-Westhues, Vincentz Network GmbH & Co KG, 2007). Examples of one-component and two-component polyurethane systems are described in the patents DE 103 08 106 A1, EP 0 996 655 A1 and EP 2 143 337 A1. Examples of commercially available adhesives based on one-component and two-component polyurethane systems are the type Korapur (from the firm of KVT-Fastening AG), Bayhydrol® (Bayer AG), Bayhydur® (Bayer AG), Desmocap (Bayer AG), and Desmodur® (Bayer AG), Kleiberit 1K PUR502.9 (Klebechemie GmbH & Co. KG).

Examples of PSA adhesives are the Duro-Tak adhesives (from the firm of Henkel), and Scotch-Weld™ adhesives (3M).

A plastisol is a suspension of a powdered thermoplastic polymer and a plasticizer as well as optionally fillers, propellants and other derivatives. PVC plastisol is also known as soft PVC, Hot Melt Vinyl.

The thickness of the adhesive layer connecting the multilayer composite is preferably selected to be between 1 μm and 50 μm, especially preferably between 5 μm and 40 μm, and especially preferably between 10 μm and 30 μm. Thinner adhesive layers tend to develop the adhesive layer in an insufficient manner, while thicker adhesive layers may lead to delamination of the multilayer composite, besides to increased adhesive consumption.

A cushioning protection against contact can be advantageously obtained for the product being stored by setting the thickness of the adhesive layer connecting the multilayer composite, as a result of which, for example, the formation of undesired pressure points is minimized during storage, transfer and/or transportation.

The thickness of the adhesive layer connecting the storage aid as a multilayer composite can be preferably varied by introducing small weight percentages of the active ingredient into an adhesive layer in quantities of less than 50 wt. %.

The adhesive layer of a storage aid according to the present invention preferably acts as a depot for a plant protectant, which is incorporated in the adhesive layer, and direct contact between the plant protectant and the environment (for example, water, aqueous solutions, water vapor) is prevented by the low polarity and high hydrophobicity of the adhesive of an adhesive layer. Chemical decomposition of the plant protectant, for example, due to alkaline or acid hydrolysis into inactive and/or toxic decomposition products is advantageously minimized hereby.

A carrier film consisting of PE and a perforated cover film made of PE, in which polyisobutylene (PIB) was used as the active ingredient-containing intermediate layer (i.e., adhesive layer), possesses especially good properties. Polyisobutylene is especially well suited because it facilitates the diffusion of the active ingredient due to its low polarity and permanently and elastically connects many different materials with one another without solvent as a toxicologically completely harmless adhesive. Other adhesive systems are also suitable, in principle, for bonding insofar as they make possible the homogeneous distribution of the active ingredient. This composition of the storage aid shall guarantee that the active ingredient passes over into the gas phase only and cannot escape the film due to segregation and cannot contaminate the product being stored in the liquid or solid form. It is especially easy to process polyisobutylene that is mixed with up to 10% of isopropyl-N-(m-chlorophenyl)-carbamate and is applied at 50° C. to 80° C. as an adhesive layer to the carrier material (PE, PP, PS, PET, PVC or even coated cellophane and other materials). A perforated PE or PP film or a nonwoven is used as the cover film. One-component and two-component polyurethane systems may also be used as other adhesives.

Plant protectants (or also called active ingredients) are, in the sense of the present invention, preferably growth regulators or fungicides, which are known to the person skilled in the art, for example, from Weed Research 26, 441-445 (1986), or “The Pesticide Manual” (10^{th} edition, The British Crop Protection Council and the Royal Soc. of Chemistry, 1994) and the literature cited therein.

The plant protectant is especially preferably a carbamate of general formula 1

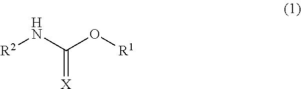

in which
R¹ and R² denote, independently from one another, an optionally substituted and/or branched C₁ to C₁₀ alkyl radical or optionally substituted aryl or hetaryl radical, and
X denotes oxygen or sulfur, preferably oxygen, or a benzimidazole.

Plant protectants known from the literature, which can, moreover, be preferably used in a storage aid according to the present invention, are the carbamates of general formula 1, preferably selected from the group comprising:
barban, propham, chlorpropham, (1S)-1-{[(1R)-1-6-fluoro-1,3-benzothiazol-2-ypethyl]carbamoyl}-2-methylpropyl]carbamic acid (benthiavalicarb), methylbenzimidazol-2-yl carbamate (carbendazim), 2-methyl-1-[1-(4-methylphenyl)ethylcarbonyl]propyl]-carbamic acid isopropyl ester (iprovalicarb), propyl[3-(dimethylamino)propyl]carbamate (propamocarb), ethyl-2-(4-phenoxyphenoxyl)ethyl carbamate (fenoxycarb), 3,5-dimethyl-4-methylmercaptophenyl-N-methyl carbamate (methiocarb), 5,6-dimethyl-2-dimethylaminopyrimidin-4-yl-N,N-dimethyl carbamate (pirimicarb), ethyl-3-phenylcarbamoyloxyphenyl carbamate (desmedipham) and methyl-3-(3-methylcarbaniloyloxy) carbanilate (phenmedipham).
   The benzimidazole is preferably 2-(4-thiazolyl)-1H-benzimidazole (thiabendazole).

The plant protectant (or active ingredient) of the storage aid according to the present invention preferably has low volatility, i.e., the relative volatility as a dimensionless characteristic, which describes the evaporation of a substance, is preferably higher than 25 and especially preferably higher than 30.

The low-volatility plant protectant of the storage aid according to the present invention preferably has a vapor pressure below 10 Pa, especially preferably lower than 10 mPa and especially preferably lower than 1 mPa at a temperature of 20° C.

An active ingredient is especially preferably a growth regulator of general formula 2:

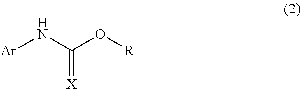

in which Ar denotes an aryl or hetaryl radical or a substituted phenyl or naphthyl radical, R denotes an optionally substituted and/or branched alkyl radical and X denotes oxygen or sulfur, preferably oxygen.

The aryl or hetaryl radical of the growth regulator according to formula 2 is especially preferably phenyl, tolyl, naphthyl, pyridyl, thienyl or isoxazolyl, especially preferably phenyl, tolyl, naphthyl, pyridyl, thienyl, and R is an iso-propyl.

A growth regulator according to formula 2 is especially preferably selected from the group comprising isopropyl-N-phenyl carbamate (CAS: 122-42-9) with a vapor pressure of 0.144 mbar at 25° C.; isopropyl-N-(m-chlorophenyl) carbamate (CAS: 101-21-3) with a vapor pressure of 0.144 mbar at 20° C., ethyl-2-pyridyl carbamate (CAS: 5255-67-4) with a vapor pressure of 0.1 mbar at 25° C., or trifluoromethyl-2-thienyl carbamate (CAS: 89564-08-9) with a vapor pressure of 5.5 mbar at 25° C.

The growth regulator according to formula 2 is especially preferably isopropyl-N-(m-chlorophenyl) carbamate.

To minimize the possible health hazards as much as possible, the application of the active ingredient was investigated, and it was found that the quantities of active ingredients used hitherto obviously had to be as high as they were only because no depot, which guarantees uniform release of the active ingredient to the ambient air, is present under the storage conditions selected. The vapor pressure of isopropyl-N-(m-chlorophenyl) carbamate (Amer. Potato Jour. 29 (1952) 268-272) is very low, but the release of active ingredient from a film that contained less than 0.5 g of active ingredient per m² was unexpectedly so high that coverage of a relatively large storage volume with this film was already fully sufficient to prevent sprouting.

FIG. 1 shows that the losses due to evaporation at a temperature of 30° C. after 30 days equal only 0.03% in case of the use of the non-volatile growth regulator isopropyl-N-(m-chlorophenyl) carbamate (CIPC).

To ensure sufficient circulation between the product being stored (for example, potatoes), it is advantageous if the film including its carrier layer itself has a coarser additional perforation.

In a preferred embodiment of the present invention, the storage aid according to the present invention has a continuous perforation, preferably a coarser additional perforation, additionally coarser punched holes or a coarser continuous perforation.

In a preferred embodiment of the present invention, the storage aid is a three-layer composite, so that the storage aid comprises only one carrier film and/or a carrier paper and a cover layer, wherein the carrier film and cover layer are connected by a permanent adhesive layer.

An alternatively preferred storage aid is a five-layer composite, wherein an additional second permeable cover layer adjoins the rear side of a carrier film and/or of a carrier paper of an above-described three-layer composite (i.e., the outer side of the carrier film and/or of the carrier paper facing away from the adhesive layer), wherein the additional second cover layer and carrier film and/or carrier paper are connected by an additional second adhesive layer. The materials of the two cover layers and/or the materials of the two adhesive layers advantageously but not necessarily differ from each other in a five-layer composite. The two cover layers may comprise both films and nonwovens. The active ingredients, which are included in an adhesive layer, may be advantageously identical or different for the respective adhesive layer in the five-layer composite.

It should be noted that the embodiments according to the present invention can be combined with one another in each arrangement.

The storage aid according to the present invention is preferably manufactured by a spray coating or laminating method, wherein a one-step or multistep coating of the surface of the carrier film and/or of the carrier paper and/or of the permeable cover layer with an adhesive layer is carried out. The growth regulator may be added to the adhesive, for example, in case of reactive adhesives, by means of a static mixer (helix-type mixer, X-element or V-element mixer) immediately before application, or the solution of the growth regulator in the adhesive, which solution has unlimited storage stability, is used.

The operational steps of a spray coating or laminating process are known to the person skilled in the art and comprise, for example,

a) one-step or multistep coating of the surface of the carrier film and/or of the carrier paper and/or of the permeable cover layer with an adhesive layer, containing the plant protectant, at a temperature between 20° C. and 100° C., preferably between 30° C. and 90° C., and especially preferably between 40° C. and 80° C.;

b) application of the carrier film and/or of the carrier paper and/or of the permeable cover layer to the surface of the film coated under a);

c) smoothing of the film composite;

d) cooling;

e) pulling off.

The process may be optionally repeated several times before rolling up a composite manufactured by means of the spray-coating or laminating process, in which case a storage aid is obtained in the form of a multilayer composite comprising more than three layers.

The incorporation of a plant protectant in the storage aid according to the present invention is not carried out according to an extrusion method (e.g., extrusion lamination, screw extrusion) at high temperatures of 140° C. to 240° C. and under a high pressure of 250 bar to 400 bar. By doing without an extrusion method for manufacturing a storage aid according to the present invention, the decomposition of the plant protectant at high temperatures is especially advantageously avoided. At the same time, high investment costs for a plant are advantageously avoided.

The fine perforation of the carrier film and/or of the cover film with holes that have a diameter of 50 μm to 3 mm is preferably carried out prior to the coating, for example, by means of needle or vacuum perforation.

The coarser additional perforation of a storage aid with holes that have a diameter larger than 3 mm, especially preferably between 3 mm and 5 mm is preferably carried out by hot needle, flame, punching, laser perforation and laserscribing. These methods are known to the person skilled in the art. A coarser additional perforation preferably has between 1 and 5 holes and especially preferably between 1 and 2 holes per cm² of the storage aid according to the present invention.

The present invention also comprises a composite material, which consists entirely or at least partially (i.e., not completely) of a storage aid according to the present invention, wherein the composite material is used, e.g., in the form of a tarpaulin or flexible web, preferably to store and/or to transport product being stored. The composite material preferably has the storage aid according to the present invention in the form of a multilayer composite, consisting of at least one carrier film and/or a carrier paper and a permeable cover layer, which are connected with incorporated plant protectant by a permanent adhesive layer.

The present invention also pertains to a container, e.g., a pallet hood, bag or sack, which consists entirely or at least partially (i.e., not completely) of a storage aid according to the present invention, wherein the container is used to package product being stored for storage and/or for transporting same. A container preferably has the storage aid according to the present invention in the form of a film composite, consisting of a carrier film and a cover film.

In the sense of the present invention, bags and sacks are hollow, deformable, preferably single-layer storage and transportation containers, which have a usually closable opening for filling with or emptying a product being stored. Containers are preferably, for example, in the form of a rectangular or funnel-shaped bag or sack.

Containers that are composed at least partially from a storage aid are preferably paper or plastic bags or bags made of a biodegradable material (for example, sisal, flax, cotton) with at least one continuous, superficial opening in the material, wherein a storage aid according to the present invention is integrated in the at least one opening in the material.

Cellulose is preferably the principal component of the paper of a paper bag. The paper of a paper bag is, furthermore, preferably unbleached and/or bleached sulfate and/or sulfite paper. It was found that paper with an area weight between 150 g/m² and above 10 g/m² is especially well suited for a container.

The storage aid according to the present invention is preferably used for storing and/or transporting the product being stored, preferably crop (for example, cereals) and other agricultural products (for example, potatoes).

The present invention also comprises the use of the storage aids according to the present invention as a multilayer composite for packaging and storing product to be stored, especially crops (for example, cereals) and/or agricultural products (for example, potatoes).

The multilayer composites prepared therefrom may be used in different ways. To ensure sufficient circulation between the product being stored (for example, potatoes), it is advantageous if the film including its carrier film itself has a coarser additional perforation. The surfaces of the storage space are coated (i.e., lined, hung) with this film or the material is used to manufacture packagings for storage, transportation and distribution.

The storage aid according to the present invention may be advantageously used at a temperature between −20° C. and 60° C., especially preferably between −10° C. and 50° C., and especially preferably between 0° C. and 40° C. for the storage and the transportation of products being stored.

In a preferred embodiment of the present invention, the storage aid is hung up in a storage space, in which case it is hung, for example, on cross beams and extends into the storage area and/or into the motion space of the storage space. Product to be stored is preferably stored in an actively air-conditioned storage space (i.e., in a closed storage facility with inner cooling), so that the air circulation is advantageously sent through the storage space and through the storage aid according to the present invention. It should be noted that an active air conditioning is not, however, necessary for the feasibility of the present invention.

Preferred are packagings in which the adhesive layer between a carrier film and a cover film has a strong adhesive action, as a result of which the stability of the storage aid according to the present invention as a permanent film composite is increased.

Especially preferred are packagings in which the thickness of the adhesive layer connecting the film composite is selected between 5 μm and 100 μm, especially preferably between 15 μm and 80 μm, and preferably between 20 μm and 60 μm, as a result of which a cushioning protection is achieved against contact for the product being stored, so that, for example, the development of undesired pressure points during storage, transfer and/or transportation is minimized.

The present invention shall be explained in more detail on the basis of the following figures and exemplary embodiments, without the present invention being limited to these. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a graph showing losses of isopropyl-N-(m-chlorophenyl) carbamate due to evaporation;

FIG. 2 is a view showing a laboratory sprout inhibition test;

FIG. 3 is a graph showing changes in the concentration of CIPC as a function of time in a large-scale test;

FIG. 4 is a view showing an example of continued storage without storage aid; and

FIG. 5 is a view showing a continued storage after hot fumigation treatment.

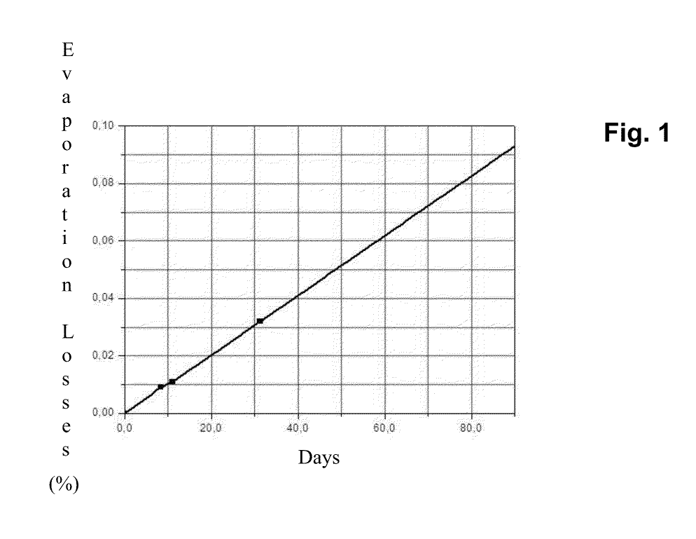

### DESCRIPTION

### Example 1

### Film Composite with Isopropyl-N-(m-chlorophenyl) Carbamate as a Plant Protectant

A mixture of 288 mg of polyisobutylene and 25 mg of isopropyl-N-(m-chlorophenyl) carbamate (CIPC) is applied to a PE carrier film measuring 0.25 m×0.25 m at 55° C. and bonded with a correspondingly dimensioned, perforated PE cover film. A corresponding film was prepared for comparison using 300 mg of polyisobutylene (PIB) without the active ingredient. 2.5 kg of potatoes each were added to two adequate containers provided with numerous round vent holes and covered with one of these films.

At a storage temperature of 20° C. and approx. 50% relative humidity, 100% sprouting with sprouts over a length of 2 cm was observed in the sample that was free from active ingredient after four weeks. The sample with the film containing active ingredient showed sprouting in only 12% of the samples after this time, and these sprouts were not longer than 5 mm and were distributed uniformly over the entire volume of the sample.

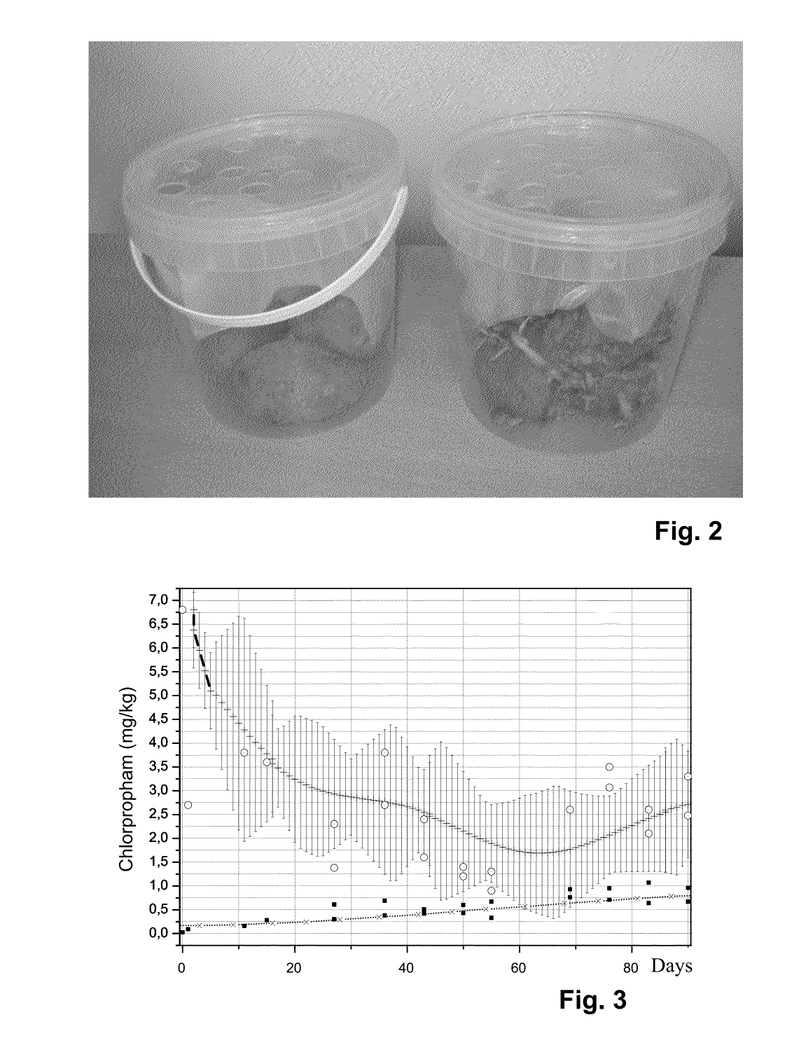

FIG. 2 shows two different samples of organic potatoes. The left-hand sample in FIG. 2 was stored in the presence of the storage aid (0.25 m×0.25 m) comprising the PE carrier film and the PE cover film. The organic potatoes in the reference sample (FIG. 2, right) were stored in the presence of a reference film of an analogous structure without CIPC. Both samples were stored in darkness over a period of 70 days at a temperature of 22° C. and a relative humidity of 54%. It can be clearly determined from Appendix 6 that sprouting inhibition is visibly suppressed by the use of a storage aid according to the present invention (FIG. 2, left). The samples stored in the presence of the reference film without CIPC (FIG. 2, right) show pronounced sprouting in darkness.

### Example 2

### Film Composite with Isopropyl-N-(m-chlorophenyl) Carbamate as a Plant Protectant

A mixture of 250 mg of a one-component polyurethane adhesive (Kleiberit PUR502.9) and 22 mg of isopropyl-N-(m-chlorophenyl) carbamate is applied to a PE carrier film measuring 0.25 m×0.25 m at room temperature (RT) and bonded with a perforated PE cover film. The reference sample without active ingredient contains 380 mg of the adhesive. 2.5 kg of potatoes each were again added to the above-mentioned two containers provided with numerous round vent holes and covered with one of these films each. Both containers were stored in darkness over a period of 14 days at a temperature of 22° C. and a relative humidity of 54%.

After 2 weeks, 100% sprouting with sprout lengths of up to 0.5 cm was observed in the container containing the sample containing no active ingredient. The sample film containing active ingredient showed sprouting in only 4% of the samples after this time, the sprouts just being visible and distributed over the entire volume of the sample.

### Example 3

### Film Composite with a Nonwoven as a Cover Layer

A mixture of 300 mg of polyisobutylene and 28 mg of isopropyl-N-(m-chlorophenyl) carbamate was applied to a PE carrier film measuring 0.25 m×0.25 m at 55° C. and bonded with a PE nonwoven. A corresponding film was prepared for comparison with the use of 300 mg of PIB without the active ingredient. 2.5 kg of potatoes each were added to the two containers and covered with one of these films each.

At a storage temperature of 20° C. and approx. 50% relative humidity, 100% sprouting with sprout lengths over 2 cm was observed after 4 weeks in the sample containing no active ingredient. The sample with the film containing active ingredient showed sprouting in only 5% of the samples after this time, and these sprouts were not longer than 5 mm and were distributed over the entire volume of the sample.

### Example 4

### Large-Scale Application of a Storage Aid

A mixture of 4.32 kg of a one-component polyurethane adhesive based on diphenylmethane diisocyanate and 480 g of isopropyl-N-(m-chlorophenyl) carbamate (CIPC) was applied at RT to a PE carrier film measuring 200 m×1.6 m and bonded with a perforated DE cover film (250 holes per cm²).

The storage aid was tested successfully in the large-scale application in a large-scale test in a commercial refrigerated storage facility with a capacity for 700 tons of potatoes at a storage temperature between 6° C. and 8° C. and a relative humidity between 85% and 95% over a test period of 90 days.

FIG. 3 shows a diagram in which the concentration of CIPC (in mg per kg of potatoes) is shown as a function of the duration of the test for different stored products.

The upper graph in FIG. 3) (circles) shows the changes in the concentration of CIPC as a function of time in a stored product treated according to conventional methods, the potatoes having been treated once by intensive hot fumigation with the growth regulator CIPC. Three to four repeated treatments of the product being stored are carried out in practice at regular time intervals.

The lower graph portion in FIG. 3 (squares) shows the changes in the concentration of CIPC as a function of time in a stored product in the presence of the above-described storage aid. The coated storage aid was fastened for this in webs on cross beams in the motion space of the storage facility.

Samples were taken from the respective storage space weekly from the middle of a storage crate. The CIPC concentration was determined in the individual samples simultaneously each time by two certified analytical laboratories.

The CIPC concentration determined in the potatoes from one stored product, which was stored in the presence of a hung-up storage aid according to the present invention (lower graph in FIG. 3) never exceeded the value of 1 mg per kg of potatoes during the entire test period. Thus, the CIPC concentration was only 1/10 of the maximum allowable concentration. At the same time, the CIPC concentration was far below the CIPC concentration of a stored product treated by single-time hot fumigation (red graph) even after a storage time of 90 days.

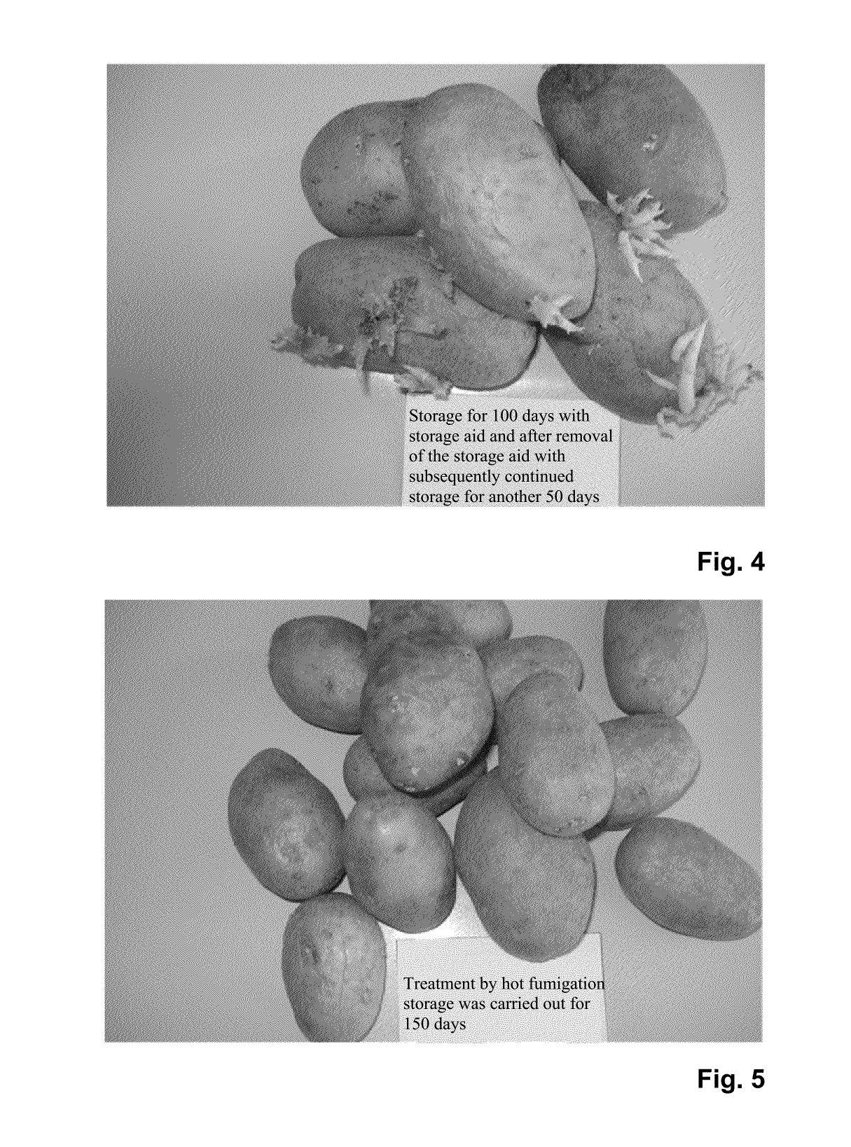

It was surprisingly found that sprouting starts in the potatoes in the storage space containing the storage aid after removal of the storage aid. FIG. 4 shows potatoes in which the storage aid was removed after a period of 100 days after storage in the presence of the above-described storage aid and storage was continued for another 50 days. Sprouting surprisingly starts in these potatoes after removal of the storage aid. A storage aid is therefore also suitable for sprouting suppression in seed potatoes for a limited period of time.

The sprouting ability is completely suppressed in potatoes that were treated according to the conventional method, i.e., intensive hot fumigation with the growth regulator CIPC (cf. FIG. 5). Therefore, seed potatoes must not, in principle, ever be treated directly with a growth regulator.

### Example 5

### Large-Scale Application of a Storage Aid

A mixture of 1.8 kg of a one-component polyurethane adhesive based on diphenylmethane diisocyanate (Kleiberit PUR502.9) and 1.8 kg of isopropyl-N-(m-chlorophenyl) carbamate (CIPC) is applied at RT to a PE carrier film measuring 150 m×1.6 m and bonded with a perforated PE cover film (250 holes per cm²).

This storage aid was tested in an analogous large-scale test in a refrigerated storage facility with a capacity for 700 tons of potatoes at a storage temperature between 6° C. and 8° C. and a relative humidity between 85% and 95% over a test period of about 90 days.

The storage aid described was fastened for this in the same manner in webs on cross beams in the motion space of the facility.

The value of 1 mg per kg of potatoes was not exceeded at the end of the test period in this case, either.

The potatoes used here could have been used as seed potatoes as well.

### Example 6

### Film Composite with Isopropyl-N-(m-Chlorophenyl) Carbamate as the Active Ingredient

A mixture of 1,250 mg of DuroTak 180-156A (acrylate copolymer in acetone/hydrocarbon) and 625 mg of isopropyl-N-(m-chlorophenyl) carbamate (CIPC) was applied at RT to a PE carrier film measuring 0.5 m×0.5 m and bonded with a correspondingly dimensioned, perforated PE cover film (350 holes per cm²). A corresponding film was prepared for comparison using 2,500 mg of DuroTak 180-156A without the active ingredient. 2.5 kg of potatoes each were added to two adequate containers provided with numerous coarser vent holes and covered with one of the films each.

Sprouting was suppressed in the sample containing active ingredient analogously to the preceding tests after 4 weeks at a storage temperature of 20° C. and 50% relative humidity.

### Example 7

### Film Composite with Propyl-[3-dimethylamino)propyl] Carbamate as the Active Ingredient

A mixture of 2,250 mg of DuroTak and 125 mg of propyl-[3-(dimethylamino)propyl]carbamate was applied at RT to a PE carrier film measuring 0.5 m×0.5 m and bonded with a correspondingly dimensioned, perforated PE cover film (250 holes per cm²). A corresponding film was prepared for comparison with the use of 2,500 mg of DuroTak without the active ingredient. 2.5 kg of potatoes each were added to two adequate containers provided with numerous round vent holes and covered with one of these films each. Fifty g of corn, which was visibly contaminated with Fusarium, was added to both samples. Sprouting was observed in both samples after 4 weeks at a storage temperature of 20° C. and approx. 50% relative humidity. However, the film containing active ingredient had completely prevented the transmission of the fungal infection to the potatoes and sprouting was even markedly reduced.

### Example 8

### Film Composite with 2-(4-Thiazolyl)-1H-Benzimidazole as the Active Ingredient

A mixture of 2,250 mg of DuroTak and 125 mg of 2-(4-thiazolyl)-1H-benzimidazole (thiabendazole) is applied at RT to a PE carrier film measuring 0.5 m×0.5 m and bonded with a correspondingly dimensioned, perforated PE cover film (150 holes per cm²). A corresponding film was prepared for comparison with the use of 2,500 mg of DuroTak without the active ingredient. 2.5 kg of potatoes each were added to two adequate containers provided with numerous round vent holes and covered with one of these films each. Fifty g of corn, which was visibly contaminated with Fusarium, was added to both samples. Sprouting was observed in both samples after 4 weeks at a storage temperature of 20° C. and approx. 50% relative humidity. However, the film containing active ingredient completely prevents the transmission of the fungal infection to the potatoes, so that it was possible to use these potatoes as seed potatoes.

While specific embodiments of the invention have been shown and described in detail to illustrate the application of the principles of the invention, it will be understood that the invention may be embodied otherwise without departing from such principles.

1. A storage aid comprising at least:
a. one carrier film and/or one carrier paper,
b. one permeable cover layer,
wherein the carrier film and cover layer are connected by an adhesive layer,
wherein the adhesive layer contains between 0.1 wt. % and 70 wt. % of a plant protectant.

2. A storage aid in accordance with claim 1, wherein the permeable cover layer is a perforated cover film or a nonwoven or a perforated paper.

3. A storage aid in accordance with claim 1, wherein the adhesive layer comprises adhesive that is a polyolefin, a polyurethane adhesive, a plastisol, an acrylate resin, a (PSA) pressure-sensitive adhesive, a natural adhesive or a mixture of one or more of a plastisol, an acrylate resin, a PSA, and a natural adhesive.

4. A storage aid in accordance with claim 1, wherein the plant protectant is a carbamate according to formula 1 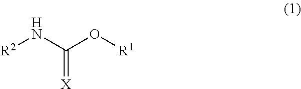
in which
R¹ and R² are, independently from one another, an optionally substituted and/or branched C₁ to C₁₀ alkyl radical or an optionally substituted aryl or hetaryl radical, and
X denotes oxygen or sulfur,
or a benzimidazole.

5. A storage aid in accordance with claim 1, wherein the plant protectant is a growth regulator according to formula 2 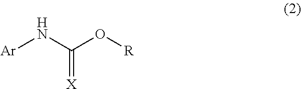
wherein Ar is an aryl or hetaryl radical or a substituted phenyl or naphthyl radical, R is an alkyl radical and X is oxygen or sulfur.

6. A storage aid in accordance with claim 5, wherein the aryl or hetaryl radical of the growth regulator according to formula 2 is a phenyl, tolyl, naphthyl, pyridyl, thienyl or isoxazolyl and R is an iso-propyl.

7. A storage aid in accordance with claim 4, wherein the growth regulator according to formula 1 is isopropyl-N-(m-chlorophenyl) carbamate.

8. A storage aid in accordance with claim 1, wherein the carrier film consists of polyethylene, polypropylene, polystyrene, polyethylene terephthalates, polyvinyl chloride, polyamide, polylactide or coated cellophane as well as blends of one or more of polyethylene, polypropylene, polystyrene, polyethylene terephthalates, polyvinyl chloride, polyamide, polylactide or coated cellophane.

9. A storage aid in accordance with claim 2, wherein the perforated cover film consists of one of polyethylene, polypropylene, polystyrene, polyethylene terephthalates, polyvinyl chloride, polylactide or coated cellophane as well as blends and the nonwoven consists of polyethylene, polypropylene, polyester, viscose and polyamide.

10. A storage aid in accordance with claim 1, wherein the storage aid has a continuous perforation.

11. A storage aid according to claim 1, wherein the storage aid is a composite material for product to be stored, wherein the composite material consists completely or at least partially of the storage aid.

12. A container for product to be stored, wherein the container consists completely or at least partially of a storage aid comprising:
a. one carrier film and/or one carrier paper,
b. one permeable cover layer,
wherein the carrier film and cover layer are connected by an adhesive layer,
wherein the adhesive layer contains between 0.1 wt. % and 70 wt. % of a plant protectant.

13. A method of aiding storage the method comprising the steps of:
coating a storage space or manufacturing packagings for storage, transportation and distribution with a storage aid comprising:
a. one carrier film and/or one carrier paper,
b. one permeable cover layer,
wherein the carrier film and cover layer are connected by an adhesive layer,
wherein the adhesive layer contains between 0.1 wt. % and 70 wt. % of a plant protectant.

14. A container in accordance with claim 12, wherein the permeable cover layer is a perforated cover film or a nonwoven or a perforated paper.

15. A container in accordance with claim 12, wherein the adhesive layer comprises adhesive that is a polyolefin, a polyurethane adhesive, a plastisol, an acrylate resin, a (PSA) pressure-sensitive adhesive, a natural adhesive or a mixture of one or more of a plastisol, an acrylate resin, a PSA, and a natural adhesive.

16. A container in accordance with claim 12, wherein the plant protectant is a carbamate according to formula 1 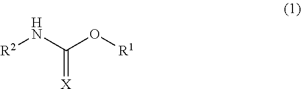
in which
R¹ and R² are, independently from one another, an optionally substituted and/or branched C₁ to C₁₀ alkyl radical or an optionally substituted aryl or hetaryl radical, and
X denotes oxygen or sulfur,
or a benzimidazole.

17. A container in accordance with claim 12, wherein the plant protectant is a growth regulator according to formula 2 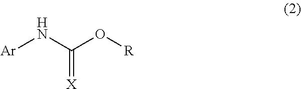
wherein Ar is an aryl or hetaryl radical or a substituted phenyl or naphthyl radical, R is an alkyl radical and X is oxygen or sulfur.

18. A method in accordance with claim 13, wherein the permeable cover layer is a perforated cover film or a nonwoven or a perforated paper.

19. A method in accordance with claim 13, wherein the adhesive layer comprises adhesive that is a polyolefin, a polyurethane adhesive, a plastisol, an acrylate resin, a (PSA) pressure-sensitive adhesive, a natural adhesive or a mixture of one or more of a plastisol, an acrylate resin, a PSA, and a natural adhesive.

20. A method in accordance with claim 13, wherein the plant protectant is a carbamate according to formula 1 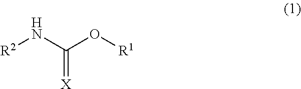
in which
R¹ and R² are, independently from one another, an optionally substituted and/or branched C₁ to C₁₀ alkyl radical or an optionally substituted aryl or hetaryl radical, and
X denotes oxygen or sulfur,
or a benzimidazole.
